(19) United States
(12) Patent Application Publication
(10) Pub. No.: US 2025/0361767 A1
(43) Pub. Date: Nov. 27, 2025

(54) PROFILE FOR WOODEN CLADDING FOR LARGE FRAMES AND RESPECTIVE FRAMES

(71) Applicant: BBG, S.A., Esposende (PT)

(72) Inventors: Miguel Sousa Araújo, Esposende (PT); Duarte João Alves Paulo, Caminha (PT)

(21) Appl. No.: 19/214,286

(22) Filed: May 21, 2025

(30) Foreign Application Priority Data
May 23, 2024 (PT) 119483

(51) Int. Cl. E06B 3/30; E06B 3/12; E06B 3/36

(52) U.S. Cl. CPC E06B 3/303; E06B 3/12; E06B 3/36

(57) ABSTRACT

The present invention concerns a profile (1) for wooden coverings to be applied to large aluminum frames, said large aluminum frames comprise fixed frames (5) in buildings (8), and sashes (6) with perimeter frames (7). The present invention covers the perimeter frames (7) of the sashes (6), and/or the fixed frames (5), as it comprises two flat faces (4a) (4b) perpendicular to each other, in the shape of an “L”, each of the flat faces (4a) (4b) comprising a longitudinal cavity (2) along its entire length to be filled by an adherent element. The profile (1) is made of modified wood, increasing its stability for application in frames.

### TECHNICAL FIELD

The present invention concerns a profile for wooden cladding to be applied to large aluminium frames and their frames and falls within the area of frames, in particular aluminium frames for doors and windows and large dimensions, more particularly to minimalist frames, in which the profiles are of reduced size, even more particularly to casement systems.

### BACKGROUND OF THE INVENTION

Increasingly, concern about comfort within buildings is a current topic. Architects, builders, users increasingly want discontinuous lines, for example in an opening to the outside, through minimalist frames, and/or between materials, for example wood and another material (concrete, metal), thus eliminating discontinuities, in addition to promoting a more compliant environment, promoting the use of fewer materials and in smaller quantities, improving the insulation of buildings. It is now possible to have large minimalist frames in which their fixed frame is covered in wood, and the vents/sashes/leaves as well. Vents is the term used in casement systems, sashes in sliding systems and leaves in door systems. At this document, these terms should be interpreted as the same, so we will use vents.

We have the case of patent document EP 19813966, in which there is a minimalist wooden structuring profile, for large spams, in a sliding system, in both interior and exterior views, not being a covering in itself, since that its application is on the fixed frame and leaf.

The Schüco AWS WoodDesign product, published at https://www.schueco.com/de-en/fabricators/products/windows/aws-wooddesign, discloses a wood cladding solution to be applied to aluminium frames, is in fact in one of the views, the interior, however, is not entirely covered, and the central view is not made of wood, as the aluminium support can be seen.

### Technical Problems Solved and Advantages

The invention arises from the need to have the option of having a large aluminium frame, sliding, swinging, casement, till and turn, side-hung, bottom-hung and top-hung system, but preferably with external or internal openings, with wooden cladding, without changing the original design of the internal and external view of the system. A cladding with a thickness between 3 and 4 mm allows achieving this goal and, in addition, the profile used guarantees sufficient inertia, allowing dimensions of 1300×3000 mm (Width×Height) (W×H), considered large frames.

In this type of frame, it must be ensured that the cladding is also minimalist and additionally that it has the ability to adhere or fit to the existing frame in a robust and effective way, not causing damage when using the frame. This type of problem in large frames, typically frames of 1300×3000 mm (W×H) is challenging, as in addition to finding a material that is sufficiently durable and stable with a thickness as small as the size of the frame, it is essential that it is effectively fixed and that it does not move unintentionally, therefore, its adhesion to the aluminium frame must be effective.

In addition to the solved problems indicated above, with the present invention it is not necessary to change the fixed frame of the system, but there is only the need to place the cladding by adhesion. In reality, the installation of the wooden cladding does not change the process of assembling the sash, as it is only glued at the end of the entire process.

The present invention solves these problems by presenting two flat faces (4a) (4b), perpendicular to each other, in the shape of an “L”, thus guaranteeing the cladding of the two visible faces of the aluminium profile of a frame-fixed frame (5) and/or perimeter frame (7) of the sash (6), and each of the flat faces (4a) (4b) has a cavity (2) located longitudinally along its entire length, which will be filled by an adherent element (3) (not shown) which guarantees proper adhesion to the aluminium. The thickness of each flat face (4a) (4b) varies between 3 mm and 4 mm, and the cavity (2) is a maximum of 1.5 mm deep so that the cladding does not break. In this way, it is also guaranteed that, in a casement system, the vents in a closed position have a central view of 58 mm and are continuously made of wood, maintaining seamless visibility of the covering materials.

The adhesive element (3) is made from a polymer consisting of a single polyether chain and methoxysilyl chain ends, and is the base resin for the production of quality sealants and adhesives for construction applications, industrial uses, DIY (Do It Yourself) and automotive, commercially known as MS polymer, thus guaranteeing its adhesion to aluminium, and the wood is modified, thus guaranteeing stability and also the fact that it does not present toxicity to the over years of use, warping and changes typical of natural wood. In this way, the use of lighter materials as cladding material is promoted and the size of the spams is still increased.

Thus, the present invention makes it possible to cover or coat the inside or outside of the sash of a large minimalist frame, and also its fixed frame (5), and this frame can be a sliding system or a casement system, covering its two areas composed of aluminium, wood, this sash belonging to a large aluminium frame, without altering the minimalist view and covering the two aluminium areas, the area of the leaves and the fixed frame (5). If the building in question itself has a wooden cladding, the view of the building with the frames is continuously covered in wood.

### DESCRIPTION OF FIGURES

FIG. 1—representation in horizontal section/cut of a frame in a casement system, where it is possible to observe the fixed frame (5), the perimeter frame (7) of the sash (6) being made of double glass, this sash without cladding, also the relationship between the frame and the outside and inside environment is represented. It is in this figure that the possibility of the fixed frame (5) having an extension (9) is represented.

FIG. 2—representation in horizontal section/cut of a frame in a casement system, where it is possible to observe the fixed frame (5), the perimeter frame (7) of the sash (6) being made of single glass, this sash with a wooden cladding with profile (1), where the flat faces (4a) (4b), perpendicular, each presenting a cavity (2). It is also represented the relationship with the outside and inside environment, and also part of a building, in this embodiment covered with wood (8) on the inside where there is the balcony for the existence of the frame. It is also possible to observe that the fixed frame (5) is also covered by the flat face (4b).

FIG. 3—representation in horizontal section/cut of a casement system, the perimeter frame (7) of two vents (6) both of which are made of double glass, and what is represented is the union of the vents in a closed position, these vents without cladding, the relationship of the frame with the outside and inside environment is also represented. Element (10) is a handle mechanism.

FIG. 4—representation in horizontal section/cut of a casement system, the perimeter frame (7) of two vents (6) both of which are made of double glass, and what is represented is the union of the vents in a closed position, these vents wooden cladding profile (1), where the flat faces (4a) (4b), perpendicular, each presenting a cavity (2). It is also represented the relationship of the frames with the inside and outside environment, and also part of the building in this case covered in wood (8) on the inside where there is the balcony for the frame. Element (10) is a handle mechanism.

FIG. 5—Isolated representation of cladding profile (1) where it's possible to observe the cavities (2) of the flat surfaces (4a) (4b).

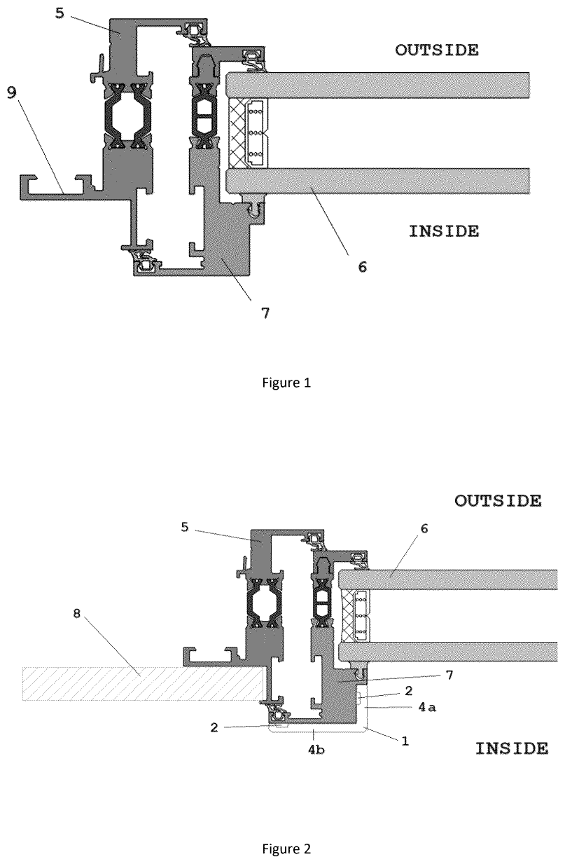

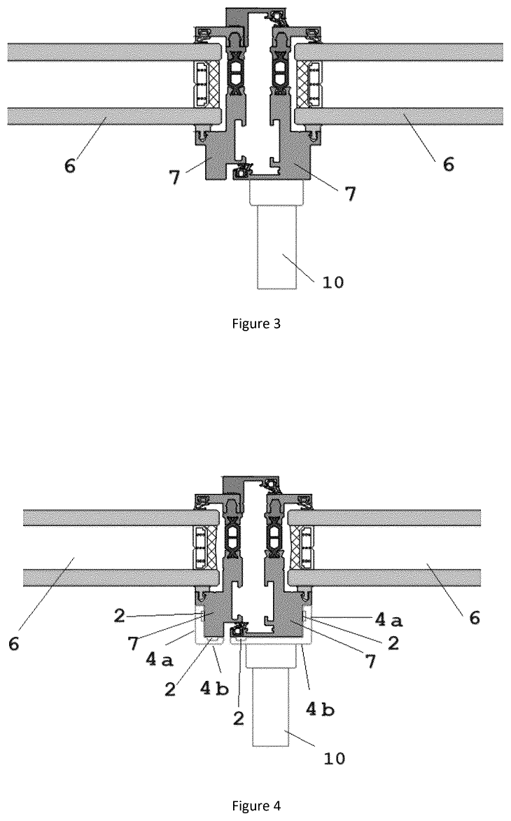

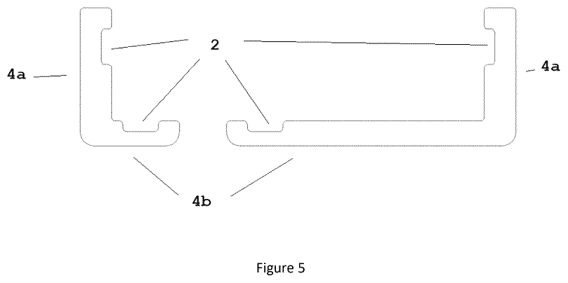

### DETAILED DESCRIPTION

The present invention concerns a profile for wooden claddings to be applied to large aluminium frames, and by frame lets understood as the set of a fixed frame (5) and at least one sash/vent/leaf (6), this sash having a perimeter frame (7); and lets understood as by fixed frame (5) the part of the frame that is fixed to a building (8) that presents the window or door.

The present invention concerns a profile (1) of a wooden cladding, this cladding comprising two flat faces (4a) (4b), perpendicular to each other, in an “L” shape, thus guaranteeing the cladding of both visible faces of the aluminium profile of a frame, and each of the flat faces (4a) (4b) has a cavity (2) located longitudinally along the entire length of each face.

These flat faces (4a) (4b) covers the aluminium profile of the sash (6), that is, the perimeter frame (7), the flat face (4b) covers the aluminium face of the perimeter frame (7) of the sash (6) which is parallel to the internal or external views, and the face (4a) covers the aluminium face of the perimeter frame of the sash (6) which is perpendicular to the internal or external views.

The thickness of each flat face (4a) (4b) varies between 3 mm and 4 mm, and its width varies between 15 mm and 40 mm, on the face parallel to the internal or external views, that is, the flat face (4b) is between 19 mm and 21 mm, preferably 20 mm, perpendicular to the internal or external views, that is, the flat face (4a), thus guaranteeing the desired minimalist view. Its extension will correspond to the size of the frame it covers. In this way, in the preferred embodiment of a profile (1) for casement system with at least two vents, a central view of the joining of the vents is guaranteed, when they are in the closed position, between 40 mm and 60 mm, preferably 58 mm and continuously in wood, maintaining seamless visibility of materials. Also, with the cladding of the fixed frame (5), the continuity of the material, wood, throughout the frame is guaranteed.

The cavities (2) are 1.5 mm deep, so that the cladding does not break and are filled by an adhesive element (3).

The adhesive element (3) is made from MS polymer, thus ensuring its adhesion to the aluminium.

The wood must be modified, thus ensuring stability and also the fact that it does not present toxicity over years of use, warping and changes typical of natural wood. In this way, the use of lighter materials as cladding material is promoted and the size of the spams is still increased.

The cladding can be placed on the internal or external side of the building, being the perimeter frame (7) of the sash (6), or the fixed frame (5), covered by said cladding by adhesion of the adherent element (3) to the aluminium.

Note that with the present invention it is not necessary to change the fixed frame, but there is only a need to place the cladding by adhesion. In reality, the installation of the wooden covering does not change the process of assembling the sash, as it is only glued at the end of the entire process.

It is also an object of this invention a large aluminium frame comprising a fixed frame (5), at least one sash (6), this sash having a perimeter frame (7) in which the perimeter frame (7) is covered by profiles (1) wherein a flat face (4a) covers the perimeter frame (7) of the sash (6) on the aluminium face that is parallel to the interior or exterior views, and the face (4b) covers the perimeter frame (7) of the sash (6) on the aluminium face that is perpendicular to the internal or external views.

In a preferred embodiment, the fixed frame (5) has an extension (9) in the direction of the building, that is, in the opposite direction to the sash (6), this extension (9) is covered with a covering material, preferably wood (8), so that material continuity is guaranteed between the building's cladding and the frame, without discontinuities.

As will be evident to one skilled in the art, the present invention should not be limited to the embodiments described in the present document, with several modifications being possible that remain within the scope of the present invention. Evidently, the preferred modes presented above are combinable, in the different possible ways, avoiding the repetition of all these combinations.

1. Wooden cladding profile (1) for large aluminum frames comprising two flat faces (4a) (4b), perpendicular to each other, in the shape of an “L”:
a) each of the flat faces (4a) (4b) comprising a cavity (2), each cavity (2) being located longitudinally along entire length of each flat face (4a) (4b);
b) the cavity (2) being filled by an adhering element (3), said adhering element (3) fixing the flat faces (4a) (4b) to the frame;
c) the wooden cladding is made of modified wood.

2. Profile (1) according to claim 1 wherein the cavity (2) has a depth of 1.5 mm.

3. Profile (1) according to claim 1 wherein the thickness of each flat face (4a) (4b) varies between 3 mm and 4 mm.

4. Profile (1) according to claim 1 wherein the width of the flat face (4b) varies between 15 mm and 40 mm and the width of the flat face (4a) varies between 19 mm and 21 mm.

5. Profile (1) according to claim 1 wherein the width of the flat face (4a) is 20 mm.

6. Profile (1) according to claim 1 wherein the adhesive element (3) is made based on MS polymer.

7. Large aluminum frame comprising a fixed frame (5), at least one vent (6), said vent with a perimeter frame (7), said perimeter frame (7) being covered by at least two profiles (1) described in claim 1 wherein:
a) a flat face (4a), of at least one profile (1), covers the perimeter frame (7) of the vent (6) at the aluminum face that is parallel to the internal or external views, and a face (4b), of at least one profile (1), covers the perimeter frame (7) of the vent (6) at the aluminum face that is perpendicular to the internal or external views.

8. Frame according to claim 7 wherein the fixed frame (5) has an extension (9) in the opposite direction to the vent (6).

9. Frame according to claim 8 wherein the extension (9) of the fixed frame (5) is covered with wood.

10. Frame according to claim 9 wherein said frame comprises at least two vents (6), covered by at least two profiles (1) described in claims 1 to 6, with the central view of the union of the at least two vents (6), when they are in the closed position, is between 40 mm and 60 mm, preferably 58 mm and continuously in wood.

11. Frame according to claim 10 wherein said frame is a casement system.
